(19) United States
(12) Patent Application Publication
(10) Pub. No.: US 2006/0165162 A1
(43) Pub. Date: Jul. 27, 2006

(54) Method and system for reducing the bandwidth access in video encoding

(76) Inventors: Ren-Wei Chiang, Taipei (TW); Ting-Kun Yeh, Taipei (TW); Jeff Yu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/337,520

(22) Filed: Jan. 24, 2006

Related U.S. Application Data
(60) Provisional application No. 60/645,739, filed on Jan. 24, 2005.

(51) Int. Cl. H04N 11/04; H04N 7/12; H04B 1/66; H04N 11/02

(52) U.S. Cl. 375/240.2; 375/240.24; 375/240.12

(57) ABSTRACT

A method and a system for reducing the bandwidth access in video encoding are disclosed. The illuminance of the search area and the illuminance of the current macro block for motion estimation are fetched from a memory by a motion estimation module. The motion estimation is performed by finding the illuminance of a most fitted macro block which best matches the illuminance of the current macro block. Then a motion compensation module fetches the chrominance of the current macro block and the chrominance of the most fitted macro block from the memory to complete the attributes of the current macro block and the most fitted macro block separately. The motion compensation is performed according to the most fitted macro block and the current macro block by the motion compensation module. Thus, the illuminance of the current macro block and the most fitted macro block are reused in the motion compensation for reducing the memory bandwidth access.

### CROSS REFERENCE TO RELATED APPLICATIONS

This application claims the benefit of U.S. Provisional Application No. 60/645,739, filed on Jan. 24, 2005, which is herein incorporated by reference for all intents and purposes.

### BACKGROUND OF THE INVENTION

1. Field of the Invention

The present invention generally relates to video encoding system and method, and more particularly to the method and system for reducing bandwidth access in video encoding.

2. Description of the Prior Art

Motion estimation (ME) is a procedure to find a search position in search area with best matching macro block. There are two main matching criteria: one is sum absolute difference (SAD), the other is mean square error (MSE). In general, macro block is a basic unit, which is an n by n pixel array when encoding a series of moving pictures, wherein n can be 16 or other number. Search area is an (n+2l) by (n+2m) pixel array based on a macro block, wherein l and m can be 4 or other numbers separately. The macro block is located on the center of the search area. Each pixel in search area is said a search position.

There are two main goals for motion compensation (MC) in video encoder. First, the motion compensation generates video predictions by using the motion estimation, then, the motion compensation gets differences between video source and predictions (these differences are input of discrete cosine transformation module). Second, motion compensation reconstructs the picture by adding the prediction and difference from inverse discrete cosine transformation and writes the reconstructed predictions into the frame buffer. Motion compensation and motion estimation are very important units in video encoder, most memory bandwidth are concentrated on these two units.

Referring to FIG. 1, motion estimation module 13 and motion compensation module 14 are used for motion estimation and motion compensation separately. The motion estimation module 13 fetches the search area 15 and current macro block 16 (current macro block, CMB) from memory via a memory interface 11 for detecting the motion. The motion identifies a prediction based on a most fitted macro block in the search area 15. The motion estimation module 13 may fetch only the luminance of the pixels arrays of search area 15 and current macro block 16. That is, the motion estimation can be a luminance search by searching for the luminance of the current macro block 16. Of course, the motion estimation can be a luminance and chrominance search, a RGB search, or the like. The luminance search is preferred because of the less memory bandwidth, computing power, and good precision.

The prediction can be the most fitted macro block or the modification of the most fitted macro block. According to the motion, the most fitted macro block can be fetched by the motion compensation module 14 for generating a prediction. Besides, the current macro block 16 must be fetched again by the motion compensation module 14 for comparing with the prediction. The difference between the current macro block 16 and the prediction will be encoded and the prediction will be restored back to the memory via the memory interface 11 for reconstructing the frame.

Because the search area 15 and current macro block 16 must be fetched over and over, the memory bandwidth is critical in encoding. The luminance costs a large part of the memory bandwidth. If the fetched luminance of current macro block 16 and search area 15 in motion estimation module 13 can be reused for motion compensation module 14, a large amount of memory bandwidth will be saved.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

Accordingly, a method and a system for reducing the bandwidth access in video encoding are disclosed. The illuminance of the search area and the illuminance of the current macro block for motion estimation are fetched from a memory by a motion estimation module. The motion estimation is performed by finding the illuminance of a most fitted macro block which best matches the illuminance of the current macro block. Then a motion compensation module fetches the chrominance of the current macro block and the chrominance of the most fitted macro block from the memory to complete the attributes of the current macro block and the most fitted macro block separately. The motion compensation is performed according to the most fitted macro block and the current macro block by the motion compensation module. Thus, the illuminance of the current macro block and the most fitted macro block are reused in the motion compensation module for recuding the memory bandwidth access.

The search area, current macro block and the most fitted macro block can be separately represented by a pixel array with a plurality of pixels. Each pixel can be identified by a plurality of attributes, including illuminance, chrominance, RGB (red, green and blue) color value and so forth. The illuminance and chrominance used by the forgoing method and system can be replaced by other attributes, such as the RGB color value.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram illustrates the prior art of the motion estimation and the motion compensation;

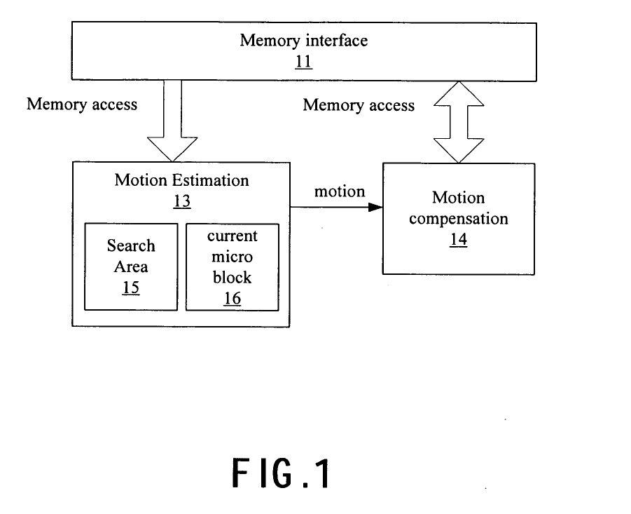

FIG. 2A is a diagram depicts a flow diagram according to one embodiment;

FIG. 2B is a diagram depicts a diagram according to one embodiment; and

FIG. 2C is a diagram depicts a diagram according to one embodiment.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

In the present invention, a method and system to reduce the memory bandwidth requirement of motion compensation is disclosed. By the method, Video encoder can encode video more smoothly and cost less memory bandwidth.

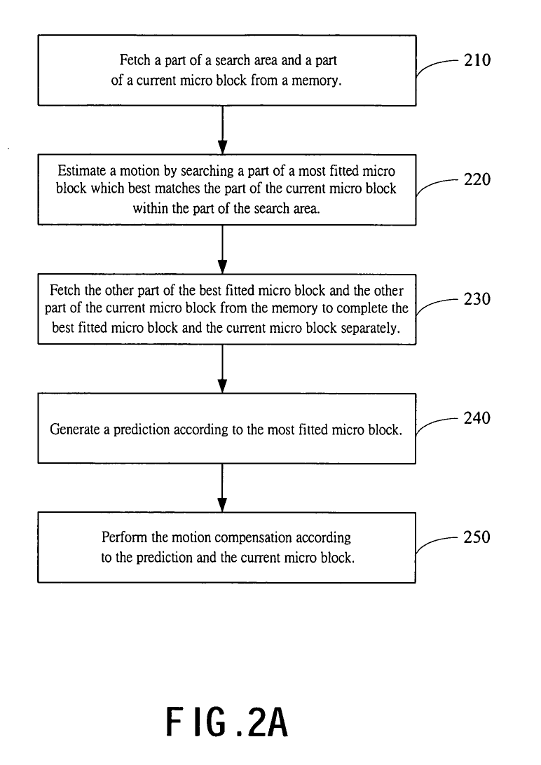

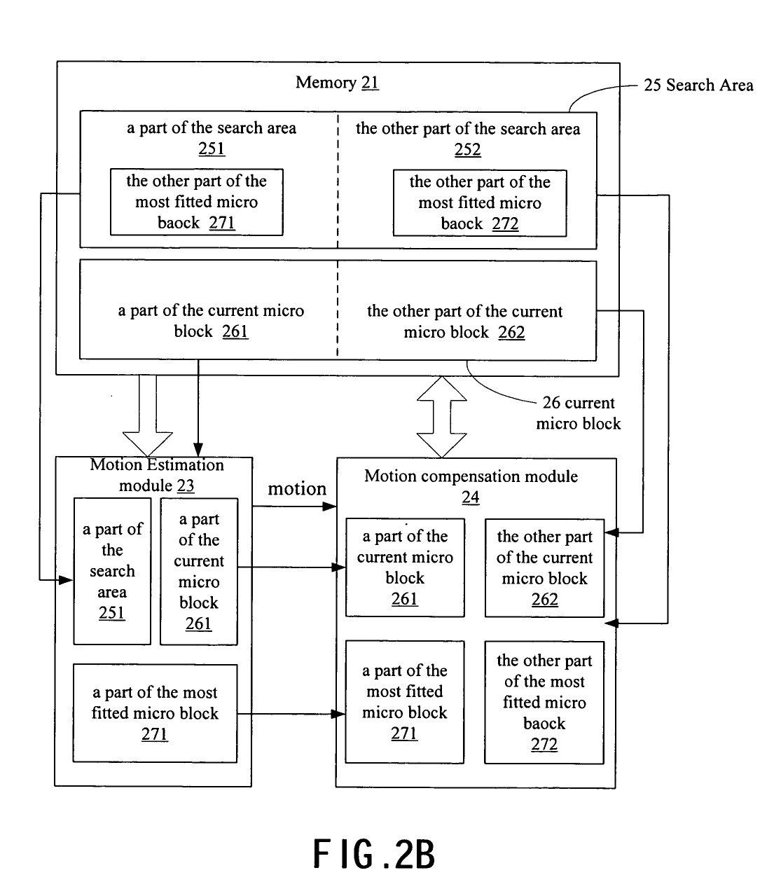

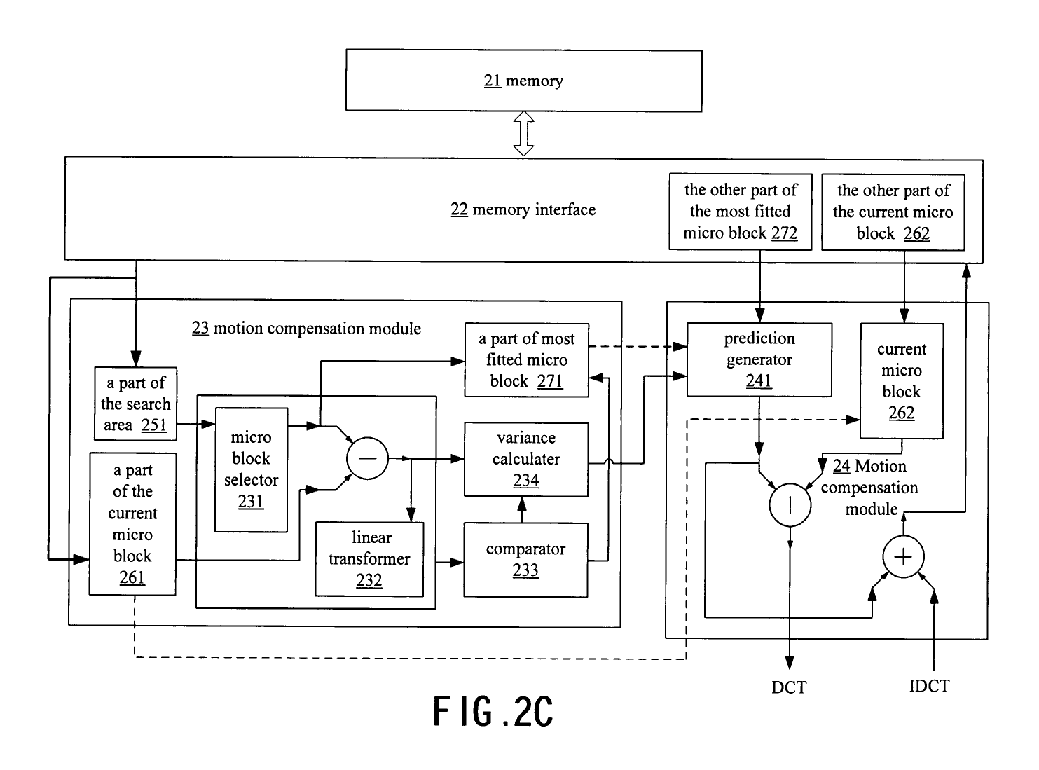

Referring to FIG. 2A, one embodiment of the present invention is a method for reducing memory bandwidth access in video encoding. First, in the step 210, fetches a part of a search area and a part of a current macro block from a memory, wherein the search area and current macro belong to different frames. Each of the search area and the current macro block can be individually presented by an array of pixels. Each pixel in the pixel array is identified by a plurality attributes, for examples, the luminance and the chrominance, the RGB color value, the Y, Cr, Cb color value and so on. The part of the search area and the part of the current macro block can be identified by a part of the attributes, for examples, the luminance. In this case, the other part of the attributes is the chrominance. Then, in the step 220, estimating a motion by searching a part of a most fitted macro block which best matches the part of the current macro block within the part of the search area. For examples, in the forgoing case, the search is a luminance search for finding the luminance of a most fitted macro block which best matches the luminance of the current macro block within the luminance of the search area. The luminance search is preferred because of the less memory bandwidth, computing power, and good precision. After the motion is found, in the step 230, fetching the other part of the best fitted macro block and the other part of the current macro block from the memory to complete the best fitted macro block and the current macro block separately. Then, in the step 240, generating a prediction according to the most fitted macro block. Afterwards, in the step 250, performing the motion compensation according to the prediction and the current macro block.

In the step 250, the embodiment of the present invention further includes performing the intrapolation or interpolation of the prediction according the difference between the most fitted macro block and the current macro block or the difference between the part of the most fitted macro block and the part of the current macro block. For examples, in the forgoing case, the difference between the luminance of the best fitted macro block and the luminance of the current macro block can be transformed into a variance. When the variance is smaller than a predefined threshold, the interpolation of the prediction is performed. Otherwise, the intrapolation of the prediction is performed.

Besides, the embodiment of the present invention can further including generating a difference between the prediction and the current macro block for the discrete cosine transformation. The difference performed by the discrete cosine transformation can be considered as a transformed difference for encoding. The embodiment of the present invention can further including receiving an input to add the prediction and restoring the sum of the input and the prediction to the memory for replacing the current macro block, wherein the input is generated by the inverse discrete cosine transformation of the transformed difference.

Referring to FIG. 2B, one embodiment of the present invention is a system for reducing memory bandwidth access in video encoding, including a motion estimation module 23 and a motion compensation module 24. The motion estimation module 23 and the motion compensation module 24 are used for motion estimation and motion compensation separately. The motion estimation module 23 fetches a part of a search area 251 and a part of a current macro block 261 from a memory 21 and estimates a motion by searching a part of a most fitted macro block 271 which best matches the part of the current macro block 261 within the part of the search area 251 according to step 210 and step 220. Then the part of the current macro block 261 and the part of the most fitted macro block 271 are received by the motion compensation module 24. Next, the motion compensation module 24 fetches the other part of the best fitted macro block 272 and the other part of the current macro block 262 from the memory 21 to complete the attributes of the best fitted macro block and the current macro block 26 separately according to step 230. Afterwards, according to step 240, the motion compensation module 24 generates a prediction according to the most fitted macro block and the current macro block 26. Finally, according to step 250, the motion compensation module 24 performs the motion compensation according to the prediction and the current macro block 26. The other details of the embodiment have disclosed in the forgoing descriptions, thus there is no more redundant discussion here.

Referring to FIG. 2C, a system for reducing memory bandwidth access in video decoding according to one of the embodiment of the present invention is provided. Memory interface 22 is used to provide memory access to memory 21 for motion estimation module 23 and motion compensation module 24. The motion estimation module 23 fetches a part of a search area 251 and a part of a current macro block 261 from the memory 21 according to step 210. The macro block selector 231 successively select one of the macro blocks within the part of the search area 251 that each of them is separately identified by one of the search positions in the part of the search area 251. The difference between each macro block selected by the macro block selector 231 and the part of the current macro block 261 is then calculated for selecting a part of a most fitted macro block 271 which best matches the part of the current macro block 261 according to step 220. The selection is performed by a linear transformer 232 and a comparator 233. The linear transformer 232 quantifies the difference between the selected macro block and the part of the current macro block 212 to generate a quantification correspondent to the selected macro block. All quantifications are compared to find out the part of the most fitted macro block 271 for generating the motion by the comparator 233. The selection of the part of the most fitted macro block 271 can be the SAD comparison, the MSE comparison, or the like, the present invention does not limit the type of the selection. For examples, if the selection is the SAD comparison, each difference will be transformed into a variance and the minimum of all variances will be selected. Accordingly, the macro block correspondent to the minimum of all variances is the part of the most fitted macro block 271.

Moreover, the motion compensation module 24 receives the part of current macro block 261 and the part of the most fitted macro block 271 from the motion estimation module 23. The motion compensation module 24 also fetches the other part of the current macro block 262 and the other part of the most fitted macro block 272 from the memory 21 to complete the attributes of the current macro block and the most fitted macro block separately according to step 230. The motion compensation module 24 includes a prediction generator 241 for generate a prediction according to the most fitted macro block and the current macro block according to step 240.

In the prior art, the motion compensation module 14 needs to fetch the most fitted macro block and the current macro block from the memory. The more frequency of the memory access of the most fitted macro block and the current macro block is higher, the more the memory bandwidth demands. If the motion compensation module does not need to fetch the part of the most fitted macro block and the part of the current macro block, a large amount of memory bandwidth can be saved and the performance can be also raised.

Besides, the differences can be evaluated to generate a macro block type for identifying the variance correspondent to the most fitted macro block by the variance calculator 234. If the current macro block and the most fitted macro block are very similar, the macro block type is inter-coding and the interpolation will be used in the prediction generator 241. Otherwise, the macro block type is intra-coding and the intrapolation could be applied.

Moreover, the part of the search area 251, the part of the current macro block 261, the part of most fitted macro block 271, the other part of the most fitted macro block 272, the other part of the current macro block 262, or the prediction could be restored in the buffers or the like within the motion estimation module 23 and motion compensation module 24.

In the prior art, the current macro block and the most fitted macro block needs to be fetched very often. For examples, a realtime video encoder for supporting DVD PAL 720×576×25 Hz needs to handle 45×36×25=40500 macro blocks per second for motion estimation. If the motion estimation search is a luminance search, then it needs to load the luminance of the current macro block for the motion estimation, and both of the luminance and the chrominance of the current macro block and the most fitted macro block for motion compensation. If the luminance cost the same bandwidth as the chrominance, the bandwidth of the luminance of the current macro block (0.5 MB (macro block)) for the motion estimation, and both of the luminance and the chrominance of the current macro block (1 MB) and the most fitted macro block for motion compensation (1 MB) are 2.5 macro blocks. According the present invention, the luminance of both of the current macro block and the most fitted macro block are not needed to be loaded for motion compensation, the bandwidth can be reduced to 1.5 macro blocks.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for reducing memory bandwidth access in video encoding, comprising:
fetching a part of a search area and a part of a current macro block from a memory, wherein each of said search area and said current macro block is individually presented by an array of pixels that each of said pixels is identified by a plurality attributes, wherein said part of said search area and said part of said current macro block are identified by a part of said attributes;
estimating a motion by searching a part of a most fitted macro block which best matches said part of said current macro block within said part of said search area;
fetching the other part of said best fitted macro block from said memory to complete said best fitted macro block for generating a prediction; and
fetching the other part of said current macro block identified by said other part of said attributes to complete said current macro block.

2. A method for reducing memory bandwidth access in video encoding of claim 1, further comprising:
generating a difference between said prediction and said current macro block and outputs said difference for the discrete cosine transformation; and
receiving an input to add said prediction and restoring the sum of said input and said prediction to memory for replacing said current macro block;
wherein said difference is performed by the discrete cosine transformation to generate a transformed difference and said input is the transformed difference generated by the inverse discrete cosine transformation.

3. A method for reducing memory bandwidth access in video encoding of claim 1, wherein said part of said attributes is the luminance and said other part of said attributes is the chrominance.

4. A method for reducing memory bandwidth access in video encoding of claim 1, further comprising transforming the difference between said part of said best fitted macro block and said part of said current macro block into a variance, and performing the intrapolation of said prediction when said variance is not smaller than a threshold.

5. A method for reducing memory bandwidth access in video encoding of claim 4, wherein further comprising performing the interpolation of said prediction when said variance is smaller than said threshold.

6. A system for reducing memory bandwidth access in video encoding, comprising:
a memory for providing a search area and a current macro block, wherein each of said search area and said current macro block can be individually presented by an array of pixels that each of said pixels is identified by a plurality attributes;
a motion estimation module for fetching a part of said search area and a part of said current macro block that is identified by a part of said attributes to estimate a motion, wherein said motion is estimated by searching a part of a most fitted macro block within said part of said search area that best matches said part of said current macro block; and
a motion compensation module for getting said motion and said most fitted macro block and fetching the other part of said most fitted macro block identified by the other part of said attributes to generate a prediction, wherein said other part of said attributes is different to said part of said attributes;
wherein said motion compensation module further fetches the other part of said current macro block identified by said other part of said attributes to complete said current macro block.

7. A system for reducing memory bandwidth access in video encoding of claim 6, wherein said motion compensation module further generates a difference between said prediction and said current macro block and outputs said difference for the discrete cosine transformation.

8. A system for reducing memory bandwidth access in video encoding of claim 7, wherein said motion compensation module further receives an input to add said prediction and restore the sum of said input and said prediction to memory for replacing said current macro block.

9. A system for reducing memory bandwidth access in video encoding of claim 8, wherein said difference is performed by the discrete cosine transformation to generate a transformed difference and said input is the transformed difference generated by the inverse discrete cosine transformation.

10. A system for reducing memory bandwidth access in video encoding of claim 6, wherein said part of said attributes is the luminance and said other part of said attributes is the chrominance.

11. A system for reducing memory bandwidth access in video encoding of claim 6, wherein said motion estimation module further transforms the difference between said part of said best fitted macro block and said part of said current macro block into a variance, and said motion compensation module further perform the intrapolation of said prediction when said variance is smaller than a threshold.

12. A system for reducing memory bandwidth access in video encoding of claim 11, wherein said motion compensation module further perform the interpolation of said prediction when said variance is smaller than a threshold.

13. A system for reducing memory bandwidth access in video encoding, comprising:
a motion estimation module for fetching the luminance of a search area and the luminance of a current macro block to estimate a motion, wherein said motion is estimated by searching the luminance of a most fitted macro block which best matches the luminance of said current macro block within the luminance of said search area; and
a motion compensation module for getting said motion and the luminance of said most fitted macro block and fetching the chrominance of said most fitted macro block to generate a prediction;
wherein said motion compensation module further fetches the chrominance of said current macro block to complete said current macro block.

14. A system for reducing memory bandwidth access in video encoding of claim 13, wherein said motion compensation module further generates a difference between said prediction and said current macro block and outputs said difference for the discrete cosine transformation.

15. A system for reducing memory bandwidth access in video encoding of claim 14, wherein said search area and said current macro block are restored in a memory and fetched from said memory to said motion estimation module and said motion compensation module.

16. A system for reducing memory bandwidth access in video encoding of claim 15, wherein said motion compensation module further receives an input and restore the sum of said input and said prediction to said memory for replacing said current macro block.

17. A system for reducing memory bandwidth access in video encoding of claim 14, wherein said difference is performed by the discrete cosine transformation to generate a transformed difference and said input is the transformed difference generated by the inverse discrete cosine transformation.

18. A system for reducing memory bandwidth access in video encoding of claim 13, wherein said motion estimation module further transforms the difference between the luminance of said best fitted macro block and the luminance of said current macro block into a variance, and said motion compensation module further perform the intrapolation of said prediction when said variance is smaller than a threshold.

19. A system for reducing memory bandwidth access in video encoding of claim 19, wherein said motion compensation module further perform the interpolation of said prediction when said variance is smaller than a threshold.

20. A system for reducing memory bandwidth access in video encoding of claim 13, wherein said search area and said current macro block are within different frames of a series of frames.
